(19) United States
(12) Patent Application Publication
(10) Pub. No.: US 2014/0053700 A1
(43) Pub. Date: Feb. 27, 2014

(54) Cutting Device

(71) Applicants: Beijing BOE Display Technology Co., Ltd., Beijing (CN); BOE Technology Group Co., Ltd., Beijing (CN)

(72) Inventors: Shoukun Wang, Beijing (CN); Xiaowei Liu, Beijing (CN); Zhaohui Hao, Beijing (CN); Liang Sun, Beijing (CN)

(73) Assignees: Beijing BOE Display Technology Co., Ltd., Beijing (CN); BOE Technology Group Co., Ltd., Beijing (CN)

(21) Appl. No.: 13/996,268

(22) PCT Filed: Jan. 9, 2013
(86) PCT No.: PCT/CN2013/070243

§ 371 Date: Jun. 20, 2013

(30) Foreign Application Priority Data
Jan. 17, 2012 (CN) 201220022594.2

(51) Int. Cl. C03B 33/10

(52) U.S. Cl. CPC C03B 33/10
USPC 83/168; 83/440.2

(57) ABSTRACT

A cutting device comprising: a protective cover (2); a glass-loading inlet (19) located at a first side of the protective cover (2); a main-frame spindle (11) located at a second side of the protective cover (2) and extending toward the inner of the protective cover (2), the second side being provided opposite to the first side; and a cutting member (12) provided on the main-frame spindle (11). Such a cutting device can achieve quick cutting upon glass within a clean space.

### TECHNICAL FIELD

Embodiments of the present invention relate to a cutting device.

### BACKGROUND

At present on a TFT-LCD production line, glass substrates are susceptible to be broken due to apparatus instability, maloperation or the like. If the dimensions of cullet are large, mishandling of the cullet tends to produce fragments and delay manufacturing schedule. Thus, it's necessary for the production line to have an apparatus used to handle the broken glass pieces quickly. When analysis is to be performed on the glass specimens, the specimens need to be cut.

However, there's yet no such simple, easily movable cullet processing apparatus on present production lines, thus when glass substrates are broken or specimen analyses are needed for the broken specimens, the large sized cullet can only be cracked and cut manually, but such manual operation is time-consuming and laborsome, that is, the manufacturing schedule is delayed while fragments are occurred, which reduces the cleanliness of a clean room and thus reduces the beneficial result.

### SUMMARY

An embodiment of the present invention provides a cutting device, which can achieve glass cutting, appropriately process large sized cullet as well as ensure the cleanliness of a clean room, and also carry out positioning cutting of glass specimens to be analyzed.

One aspect of the present invention provides a cutting device, comprising: a protective cover; a glass-loading inlet located at a first side of the protective cover; main-frame spindle located at a second side of the protective cover and extending toward the inner of the protective cover, the second side being provided opposite to the first side; and a cutting member provided on the main-frame spindle.

For example, the above cutting device may further comprise: a shaft-sliding rail located on a bottom surface of the protective cover, below the main-frame spindle and horizontal with respect to or perpendicular to the main-frame spindle, and slidably connected with the main-frame spindle.

For example, the above cutting device may further comprise: a supersonic vibrating member provided on the main-frame spindle.

For example, the above cutting device may further comprise: a first cleaning member provided on the main-frame spindle.

For example, the above cutting device may further comprise: a second cleaning member located at a bottom surface of the protective cover and can reciprocally move on the bottom surface; the first side of the protective cover also has a cullet recovery port below the glass-loading inlet and at the same level as the cleaning part of the second cleaning member.

For example, the above cutting device may further comprise: a first sliding closure located at a top surface of the protective cover and slidably connected with the top surface; and/or a second sliding closure located outside the glass-loading inlet at the first side of the protective cover and slidably connected with the first side.

For example, the above cutting device may further comprise: a placement box connected with a bottom surface of the protective cover through an elevating member and used for the placement of the elevating member; an electrically-driven cassette provided on the first side of the placement box; an operating handle provided on a sidewall of the electrically-driven cassette and connected with the elevating member.

For example, the above cutting device may further comprise: a telescopic rail located at the bottom surface of the protective cover and connected with the operating handle; and/or a rotating regulator located at the lower surface at the bottom side of the protective cover and connected with the operating handle.

For example, the above cutting device may further comprise: a recovery tank located on the second side of the placement box, and the first side of the placement box located opposite to the second side of the placement box; and/or a dust-sucking member located on a sidewall of the recovery tank.

As to the cutting device, for example, the cutting member is a 360°-rotatory cutting gear or a diamond cutter or an optical cutting device.

The embodiment of the present invention is able to achieve glass cutting, appropriately process large sized cullet as well as ensure the cleanliness of a clean room, and also carry out positioning cutting of glass specimens to be analyzed.

### BRIEF DESCRIPTION OF THE DRAWINGS

In order to illustrate the technical solutions of the embodiments of the present invention more clearly, simply introduction about the drawings of the embodiments will be made in the following, and obviously, the drawings described below relate to only part of the embodiments of the present invention, rather than limitation to the present invention.

FIG. 1 is a structural drawing of a cutting device according to a first embodiment of the present invention; and

FIG. 2 is a structural drawing of a cutting device according to a second embodiment of the present invention.

### REFERENCE NUMBER

1: first sliding closure; 2: protective cover; 3: telescopic rail; 4: first shaft-sliding rail; 5: first cleaning member; 6: supersonic vibration member; 7: rotating regulator; 8: electrically-driven cassette; 9: operating handle; 10: the second sliding closure; 11: main-frame spindle; 12: cutting member; 13: cutlet recovery port; 14: second cleaning member; 15: elevating member; 16: recovery tank; 17: dust-sucking member; 18: placement box; 19: glass-loading inlet; 20: second shaft-sliding rail.

### DETAILED DESCRIPTION

To make clearer the object, technical solutions and advantages of the embodiments of the present invention, a clear and full description of the technical solution of the embodiment of the present invention will be made with reference to the accompanying drawings of the embodiment of the present invention. Obviously, the described embodiments are merely part of the embodiments of the present invention, but not all the embodiments. Based on the described embodiments of the present invention, all the other embodiments acquired by the ordinary skilled in this art, without any creative labor, fall into the protective scope of the present invention.

Unless otherwise defined, the technical or scientific terminology used herein should have common meanings to be understood by the ordinary skilled in this art of the present invention. The terms “first”, “second” as well as similar words, used in the patent application specification and claims of the present invention, do not mean any sequence, quantity or importance, but are used to distinguish different components. Similarly, phrases such as “a”, “an” or “the” do not mean quantitative limitation, but refer to the existence of at least one object. Phrases such as “comprise”, “contain” and the like intend to mean that the elements or articles present before the phases encompass the elements or articles listed after the phases, and do not exclude other elements or articles. Phrases such as “connected to” or “coupled with” are not limited to physically or mechanically connection, but include electrically connection, no matter direct or indirect. Further, phrases “upper”, “lower”, “left”, “right” etc are used only for describing a relative positional relationship, which will be varied correspondingly when the described objects are changed in its absolute position.

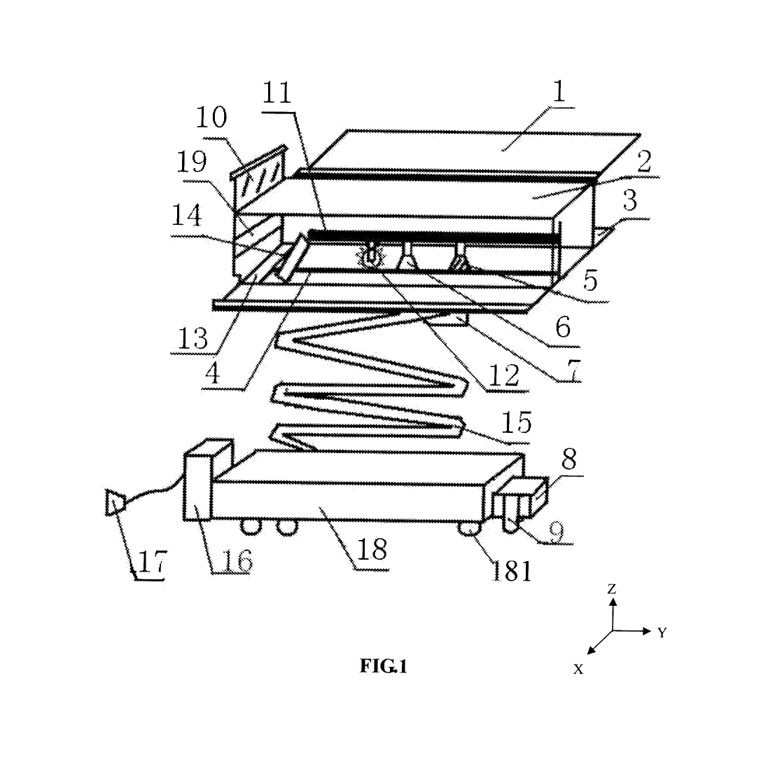

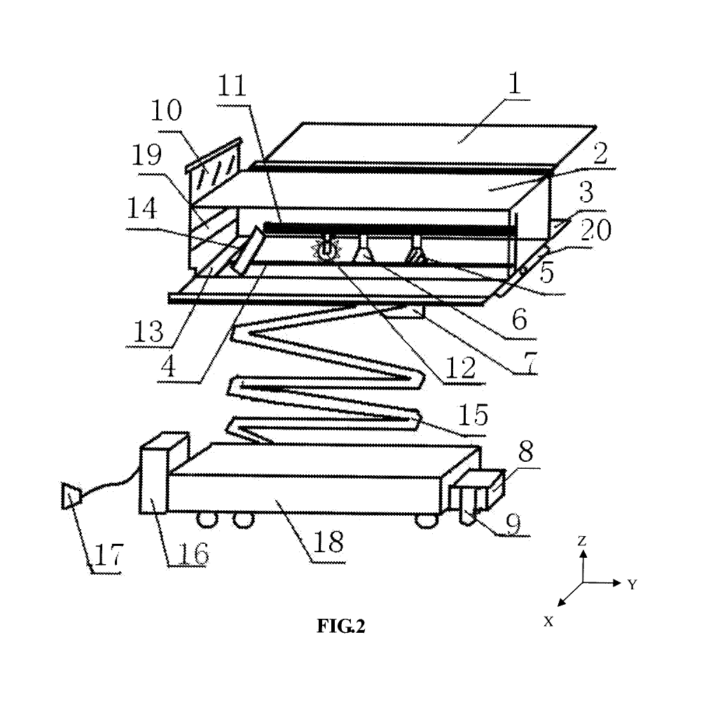

As shown in FIGS. 1 and 2, the cutting device of an embodiment of the present invention comprises: a protective cover 2; a glass-loading inlet 19 located at a first side of the protective cover 2; a main-frame spindle 11 located at a second side of the protective cover 2 and extending toward the inner of the protective cover 2, the second side being provided opposite to the first side; a cutting member 12 provided on the main-frame spindle 11, for example, a saw web or cutter blade. The horizontal position where the glass-loading inlet 19 is positioned is at the same level as the central portion of the cutting member 12, so that cutting of the glass brought into the protective cover 2 though the glass-loading inlet 19 can be realized. Further, a protrusion configuration (not shown in the drawings) may also be provided at the glass-loading inlet 19 on the first side, for even more firmly holding the glass when the glass is entering; alternatively, a supporting configuration (not shown in the drawings) may be positioned on the bottom side of the protective cover 2, for even more firmly holding the glass when the glass is entering; the protective cover 2 preferably is in a quadratic form, in particular, a square form or a rectangular form, and the inner portion of which is an accommodation space formed by the first side, the second side, the bottom surface and the top surface, the main-frame spindle 11 is located in the accommodation space of the protective cover 2; the cutting member 12 particularly may be a cutting gear, preferably, a 360°-rotatable cutting gear, and also may be a diamond cutter, further may be an optical cutting device, such as laser cutting device, facilitating the cutting of glass.

Further, as shown in FIG. 1, the above cutting device may further comprise: a first shaft-sliding rail 4 provided on the bottom surface of the protective cover 2, the first shaft-sliding rail 4 is located below the main-frame spindle 11 and provided to be horizontal with respect to the main-frame spindle 11, the first shaft-sliding rail 4 is slidably connected with the main-frame spindle 11, and the main-frame spindle 11 can slide on the first shaft-sliding rail 4 so as to regulate the cutting position of the glass and eventually achieve a positioning cutting.

Further, as shown in FIG. 2, the above cutting device may further comprise: a second shaft-sliding rail 20 provided on the bottom surface of the protective cover 2, the second shaft-sliding rail 20 is located below the main-frame spindle 11 and perpendicular to the main-frame spindle 11, the second shaft-sliding rail 20 is slidably connected with the main-frame spindle 11, and the main-frame spindle 11 can slide on the second shaft-sliding rail 20 so as to regulate the cutting position of glass and eventually achieve positioning cutting.

Further, the cutting device shown in the above FIG. 1 or 2 may further comprise: a supersonic vibrating member 6 provided on the main-frame spindle 11 so as to perform vibrating cutting of the glass fed into the protective cover 2 through the glass-loading inlet 19.

Further, the cutting device shown in FIG. 1 or 2 may further comprise: a first cleaning member 5 provided on the main-frame spindle 11, so as to clean the cullet produced after cutting to ensure the cleanliness of the environment within the protective cover.

Further, the above cutting device shown in FIG. 1 or 2 may further comprise: a second cleaning member 14 provided on the bottom surface of the protective cover 2, which can reciprocally move on the bottom surface, so as to clean the cullet remained on the bottom, or alternatively, the above first cleaning member 5 may be further used to thoroughly clean the cullet remained on the bottom, thereby the cleanliness of the environment within the protective cover can be farther ensured. The first cleaning member 5 and the second cleaning member 14 can be implemented as brushes.

The first side of the protective cover 2 also has a cullet recovery port 13, which is provided below the glass-loading inlet 19 and at the same level as the cleaning part of the second cleaning member 14, so as to recover the cullet through the cullet recovery port 13 after cleaning.

Further, the cutting device shown in FIG. 1 or 2 may further comprise: a first sliding closure 1 provided at a top surface of the protective cover 2 and slidably connected with the top surface; the first sliding closure 1 slides to one side of the protective cover 2 before cutting by the cutting device, and slides to close the protective cover 2 during cutting to avoid bouncing out of cullet; and/or the cutting device may comprises a second sliding closure 10 provided outside of the glass-loading inlet 19 of the first side of the protective cover 2 and slidably connected with the first side, which slides away before feeding glass and slide back to close the glass-loading inlet 19 after feeding of glass.

Further, the above cutting device shown in FIG. 1 or 2 may further comprise: a placement box 18 connected with the protective cover 2 by means of an elevating member 15 and used for the placement of the elevating member 15; a electrically-driven cassette 8 provided at the first side of the placement box 18; an operating handle 9 provided on a sidewall of the electrically-driven cassette 8, which is connected with the elevating member 9. The elevating member 15 may be a collapsible supporting frame, and presents a shape of the letter “Z” after spreading out, and, under the regulation of the operating handle 9, regulates the height of the protective cover 2 in the upper portion of the cutting device and other devices provided on the protective cover 2 to facilitate operation; the placement box 18 accommodates the elevating member 15 when the elevating member 15 goes down; and the electrically-driven cassette 8 affords power supply for the whole cutting device.

Further, the above cutting device shown in FIG. 1 or 2 may further comprise: a telescopic rail 3 provided on the bottom surface of the protective cover 2 and connected with the operating handle 9; and/or a rotating regulator 7 provided on the lower surface of the bottom side of the protective cover 2 and connected with the operating handle 9. The telescopic rail 3 can achieve regulation of the spacing distance of the above protective cover 2 as well as other devices under the control of the operating handle 9, and the rotating regulator 7 can, through the control by the operating handle 9, achieve 360°-rotation of the protective cover 2 at the horizontal plane and further achieve positioning of the glass-loading inlet 19 and the cutting member 12.

Further, the above cutting device shown in FIG. 1 or 2 may further comprise: a recovery tank 16 provided at the second side of the placement box 18, the recovery tank 16 is located right below the cullet recovery port 13 and used for storage of glass that is recovered through the cullet recovery port 13, and the first side of the placement box 18 is provided opposite to the second side of the placement box 18; and/or

The cutting device may further comprises a dust-sucking member 17 provided at a sidewall of the recovery tank 16, and the dust-sucking member 17 is for example a vacuum cleaning parts, achieving cleanup of the dust within the recovery tank 16.

In the embodiment of the present invention, other sides of the protective cover 2 than the first side, the second side, the top surface and the bottom surface can be fixedly or movably connected with the first side, the second side, the top surface and the bottom surface of the protective cover 2. Of course, when the cutting device performs glass cutting, the whole protective cover should be closed so as to ensure that the cut cullet unlikely drop outside of the protective cover and thus avoid hurt to people or pollution to environment by the cullet.

Again as shown in FIG. 1, the operation process of the above cutting device will be described as follows.

When cullet occurs on the production line, the operating handle 9 and electrically-driven cassette 8 are used to drive the cutting device arrive at the destination, preferably, the portion of the underside of the placement box 18 contacting the ground may further have wheels 181.

Next, the operating handle 9 is used to regulate the elevating member 15 and the telescopic rail 3 to achieve the regulation of the height (z-direction) and the distance (x-direction), preferably, the bottom of the above protective cover 2 also have a rotating regulator 7, and the rotating regulator 7 can be regulated so as to move the cutting member 12 to the desired place, thus facilitating feeding the glass into protective cover 2 of the device.

Next, the first sliding closure 1 is moved away by the operating handle 9, and cullet will be placed into this cutting device, if the cullet is of large sizes or the glass is just cracked, the mechanical arm on the production line may be operated to feed the cutlet, through the second sliding closure 10 at one side of the protective cover, along the Y-direction (the y-axis is a coordinate axis perpendicular to the x-axis in horizontal direction) and into the protective cover 2 of the cutting device.

After the cullet is completely placed into the cutting device, the operating handle 9 is used to close the first sliding closure 1 and the second sliding closure 10, and retract the cutting device along the x-direction and recede the cutting device along the z-direction to its original position, then the elevating member 15 will be stacked in the placement box 18; when the protective cover 2 is closed, the operating handle 9 is used to regulate the cutting member 12 and the supersonic vibrating member 6 to cut and crack the glass, and if positioning cutting of specimens is needed, the operating handle 9 may be used to regulate the main-frame spindle 11 to move on the first shaft-sliding rail 4 or on the shaft-sliding rail 20 and regulate the cutting member 12 to move on the main-frame spindle 11, so that it's possible to achieve translation, as a whole, of the cutting member 12 (e.g., a cutting gear), the supersonic vibrating member 6 and the first cleaning member 5, and finally achieve the positioning cutting, and thereby the cutting position can be regulated and positioning cutting and sampling can be realized.

Next, the cullet recovery port 13 is open, and the cut cullet of large sizes is cleaned-up by the second cleaning member 14, and a thorough clean-up is further performed with the first cleaning member 5, then the cullet is swept into the recovery tank 16, the apparatus on the production line having cutlet is cleaned-up with a dust-sucking member 17, thereby, achieving the function of handling the cullet or cutting specimen quickly and conveniently while depressing the occurrence of cullet.

After completing the cleaning of the cullet, the elevating member 15 of the apparatus is stacked into the placement box 18, while other devices are restored. The above elevating member 15 can be formed by a telescopic long axis.

Accordingly, the above cutting device is an apparatus easy to be transported and capable of dealing with the cullet quickly while being designed based on the current requirement, which device can, when the glass is broken, duly process the large sized cullet while ensuring cleanliness, and further can perform positioning cutting of the glass specimens to be analyzed and ensure manufacturing schedule as well.

The above described are only exemplary embodiments of the present invention, but not intend to limit the protective scope of the present invention, and the protective scope of the present invention is defined by the appended claims.

1. A cutting device, comprising:
a protective cover;
a glass-loading inlet located at a first side of the protective cover;
a main-frame spindle located at a second side of the protective cover and extending toward the inner of the protective cover, the second side being provided opposite to the first side; and a cutting member provided on the main-frame spindle.

2. The cutting device according to claim 1, further comprising:
a shaft-sliding rail located on a bottom surface of the protective cover, below the main-frame spindle and horizontal with respect or perpendicular to the main-frame spindle, and slidably connected with the main-frame spindle.

3. The cutting device according to claim 1, further comprising:
a supersonic vibrating member provided on the main-frame spindle.

4. The cutting device according to claim 1, further comprising:
a first cleaning member provided on the main-frame spindle.

5. The cutting device according to claim 1, further comprising:
a second cleaning member located at a bottom surface of the protective cover and can reciprocally move on the bottom surface;
wherein the first side of the protective cover has a cullet recovery port below the glass-loading inlet and at the same level as the cleaning part of the second cleaning member.

6. The cutting device according to claim 1, further comprising:
a first sliding closure located at a top surface of the protective cover and slidably connected with the top surface; and/or
a second sliding closure located outside the glass-loading inlet at the first side of the protective cover and slidably connected with the first side.

7. The cutting device according to claim 1, further comprising:
a placement box connected with a bottom surface of the protective cover through an elevating member and used for the placement of the elevating member;
an electrically-driven cassette arranged at the first side of the placement box; and
an operating handle provided on a sidewall of the electrically-driven cassette and connected with the elevating member.

8. The cutting device according to claim 1, further comprising:
a telescopic rail located at a bottom surface of the protective cover and connected with the operating handle; and/or
a rotating regulator located at a lower surface at the bottom side of the protective cover and connected with the operating handle.

9. The cutting device according to claim 1, further comprising:
a recovery tank located on the second side of the placement box, and the first side of the placement box located opposite to the second side of the placement box; and/or
a dust-sucking member located on a sidewall of the recovery tank.

10. The cutting device according to claim 1, wherein,
the cutting member is a 360°-rotatory cutting gear or a diamond cutter or an optical cutting device.
